(19) United States
(12) Patent Application Publication
(10) Pub. No.: US 2023/0053050 A1
(43) Pub. Date: Feb. 16, 2023

(54) ELECTRIC SURFACE TEMPERATURE CONTROL SYSTEM AND A LAYING DEVICE FOR A HEATING CABLE OF THE ELECTRIC SURFACE TEMPERATURE CONTROL SYSTEM

(71) Applicant: INFINEX HOLDING GMBH, Haiterbach (DE)

(72) Inventors: Martin Hartl, Horb (DE); Thomas Hirmer, Haiterbach (DE)

(21) Appl. No.: 17/884,640

(22) Filed: Aug. 10, 2022

(30) Foreign Application Priority Data
Aug. 11, 2021 (DE) 102021120939.0

(51) Int. Cl. F24D 13/02; H05B 3/56; B32B 5/02; B32B 7/12; B32B 27/12; B32B 27/32; B32B 3/30; B32B 3/06

(52) U.S. Cl. CPC F24D 13/024; H05B 3/56; B32B 5/022; B32B 5/028; B32B 7/12; B32B 27/12; B32B 27/32; B32B 3/30; B32B 3/06; B32B 2255/10; B32B 2262/0253; B32B 2307/732; B32B 2471/04

(57) ABSTRACT

Electric surface temperature control system for a floor, wall or ceiling construction, with at least one heating cable, with at least one carrier plate, which includes a first plate side, which is provided to rest on a ground and includes a second plate side, which is opposite the first plate side and is provided for receiving a contact agent, such as mortar or adhesive, and with a first functional layer arranged on the second plate side, and a second functional layer is provided on the heating cable at least in sections, said second functional layer is formed from a hook tape and the heating cable can be fastened on the carrier plate by the first functional layer and second functional layer with the formation of a hook-and-loop fastener.

The invention relates to an electric surface temperature control system for a floor, wall or ceiling construction and to a laying device for a heating cable of the electric surface temperature control system.

Two different technologies are known for surface temperature control of a floor, wall or ceiling structure. On the one hand, such surface temperature control is achieved due to water flowing through pipes that are laid in the ground. On the other hand, heating cables are energised, which are applied to the ground.

Electric underfloor heating systems are well known. These consist of so-called heat mats, which are known under www.fussbodenheizungdirekt.de/elektroheizung, for example. Such heating mats consist of a rollable thin-layer mat on which heating cables for electric underfloor heating are pre-laid and fixed in a meandering pattern on the thin-layer mat. Such thin-layer mats with pre-laid heating cables are rolled out on the existing ground, such as screed. An adhesive or mortar is applied to this thin-layer mat to bond it to the ground, in particular screed, and on the other hand to bond a floor, wall or ceiling covering to the ground, in particular screed.

Such heat mats for the formation of electric underfloor heating allow a low degree of flexibility in adapting to the geometry or cut of the room, as the thin-film mat has a predefined sheet width. In addition, the electrical heating cables pre-laid on it should not be removed from the thin-film mat, cut or otherwise laid.

The invention is based on the object of proposing an electric surface temperature control system for a floor, wall or ceiling structure, which enables heating cables to be laid in a simple manner and which can be individually adapted to the size and layout of the room. Furthermore, the invention is based on the object of proposing a laying device by means of which a heating cable of the electric surface temperature control system can be laid in a room in a simple manner.

This object is achieved by an electric surface temperature control system for a floor, wall or ceiling construction, which comprises at least one heating cable, which can be arranged on at least one carrier plate, wherein the at least one carrier plate is designed as a film-like plate made of plastic, which can be designed to be flat or profiled, and has a first plate side, which is provided for resting on the ground, and comprises a second plate side, which is located opposite the first one and is provided for receiving a contact agent, such as mortar or adhesive, which cures in order to form a contact layer with the surface covering which is to be applied, and has a first functional layer arranged on the second plate side, wherein the first functional layer arranged on the second plate side is formed from a fibrous layer, and a second functional layer is provided on the heating cable at least in sections, which second functional layer is formed from a hook tape, and the heating wire can be fastened on the carrier plate by forming a hook-and-loop fastener between the functional layer and the second functional layer. This electric surface temperature control system has the advantage that simple laying and adaptation to the geometry or the cut of the room as well as to a distribution of a heating power within the room is possible. The carrier plate, which is preferably in the form of a sheet, can be easily adapted to the geometry of the room by cutting it to size. The heating cable can then be laid on the carrier plate(s), whereby the course of the heating cable is simple and can be freely selected. For example, a meandering positioning of the heating cable on the carrier plate can be provided, wherein the distances and/or size of the windings can be aligned as desired. For example, the heating cables can be arranged more densely in an area close to a window or an outer wall than, for example, in a more distant area in the room.

Preferably, the carrier plate, which is a film-like plate made of plastic, is formed with a plurality of chambers formed by recesses and/or elevations from a plane of the film-like plate, wherein the outer end faces of which form the first plate side and the remaining opposing surface portions form the second plate side. Such a carrier plate furthermore has the advantage that an uncoupling, in particular voltage and/or sound decoupling is provided between the surface covering supported by the carrier plate and the ground, in particular screed.

The carrier plate preferably has wall portions, which extend between the end faces of the chambers forming the first plate side and surface portions connecting the chambers, which form the second plate side, and run perpendicularly or conically tapering to the end faces of the chambers. Thus, undercut-free recesses are formed in which the curable contact agent for fixing the surface covering to the carrier plate can be introduced in a simple manner.

Furthermore, it is preferred to make the film-like plate from a thermoplastic elastomer, in particular from HDPE, PE or PP. Such film-like plates have sufficient stiffness for uncoupling and can also be easily cut to size.

Furthermore, the first functional layer preferably consists of a sheet-like material and is at least partially or completely laminated, glued or welded onto the second plate side of the carrier plate. Thus, a simple pre-fixation of the heating cable must be possible. An improved adhesion of the contact means to the film-like plate is possible in order to receive the surface cladding in an improved manner.

Furthermore, it is preferably provided that in a carrier plate having a plurality of chambers formed by recesses, the first functional layer is fastened to the surface portions and spans the recesses or lines the recesses of the chambers.

Furthermore, the first functional layer is preferably formed as a felt layer, a non-woven layer, a fibrous fabric or net-like fibrous fabric. Preferably, synthetic fibres are used.

The second functional layer, which surrounds the heating cable at least in sections, is preferably strip-shaped so that it surrounds the heating cable in a helix or spiral. Alternatively, the second functional layer can also be formed by at least one longitudinal strip aligned longitudinally to the heating cable and provided thereon. The longitudinal strip can partially or completely surround the sheathing of the heating cable.

According to an alternative embodiment, the heating cable may have a sheath in which the hook tape is integrated facing the outside.

The heating cable may preferably be fastenable to the surface portions of the second plate side resting on and/or spanning the recesses of the chambers on the surface portions of the second plate side extending between the recesses. This allows any course for laying the heating cable on the carrier plate.

According to a further preferred design, the carrier plate can have a third functional layer on the first plate side, which functional layer preferably extends flat, and preferably the third functional layer is a fabric or non-woven. In the case of a carrier plate with recesses, the third functional layer extends in the plane of the first plate side. In particular, this facilitates an adhesion between the carrier plate and the ground or screed. This third functional layer preferably does not line the recesses extending from the first plate side. This allows a free region of mortar to be provided between the recesses, which is intended for bonding the first plate side to the ground, in particular screed.

Furthermore, the carrier plate or the carrier plate with the first functional layer on the second plate side or the carrier plate with the first functional layer on the second plate side and the third functional layer on the first plate side preferably has a height of less than four millimetres. Together with the heating cable, on which the second functional layer is provided, this enables the entire electric surface temperature control system to be retrofitted on existing floors; for example, to retrofit individual rooms with electric surface temperature control.

The object of the invention is further achieved by a laying device for a heating cable of an electric surface temperature control system, in particular according to one of the embodiments described above, wherein the laying device comprises a handle, a guide rod on which the handle is provided and, remote from the handle, a roller arranged on the guide rod, as well as a cable feed, through which a heating cable comprising a second functional layer, in particular in the form of a hook tape, can be fed to the roller and rolled along a guide on or in the roller during application on the carrier plate, so that the heating cable with the second functional layer is provided on a carrier plate on the first functional layer or in the roller during application to the carrier plate, so that the heating cable with the second functional layer can be fastened to a carrier plate provided on the first functional layer. This laying device is very easy to set up and use.

The guide rod preferably has a length such that, with a roller resting on the carrier plate, the handle arranged on the guide rod is provided at a height such that an operator in an upright position can guide and move the guide rod by means of the roller on the carrier plate.

The guide rod is preferably tubular, wherein the cable feed advantageously takes place within the guide rod. Alternatively, at least one guide tab can be provided on the guide rod through which the heating cable is fed along the guide rod of the roller. The cable feed can also only take place partially or in sections within the guide rod.

Furthermore, the guide rod preferably has a curved end portion at the end facing the roller, which curved end portion points towards the guide on or in the roller. This allows the supplied heating cable to be forcibly bent before exiting the cable feed, enabling simplified deflection on the roller.

Alternatively, it may be provided that the guide rod comprises a guide portion for the heating cable at an end facing the roller, which guide portion is formed by two tabs formed at the end of the guide rod, which preferably extend in parallel to each other, wherein the tabs particularly rotatably receive the roller. Advantageously, the length of the tabs is formed such that a restricted guidance of the heating cable onto the guide of the roller takes place.

The guide of the roller is preferably formed by a circumferential ridged recess. This recess is semi-circular or circular in cross-section so that the heating cable can rest in it and is preferably guided laterally.

The roller of the laying device preferably has a radius, which corresponds to at least a distance of two recesses in a carrier plate. This can enable safe and even rolling on a carrier plate, which comprises chambers formed by recesses. This means that the heating cable can also be laid spanning recesses in the carrier plate.

A further advantageous design of the laying device provides that a stand is provided adjacent to the roller on the guide rod. For example, this stand is in the form of a plate. This may allow the laying device to be held independently in a standing position when not in use.

Furthermore, it is preferably provided that a reel for supplying the heating cable is rotatably and preferably replaceably provided on the guide rod. This arrangement has the advantage that a handleable unit is given. The reel can be carried along simultaneously with the guide rod during the laying of the heating cable without additional handling.

Furthermore, it is preferably provided that a through axle is fastened to the guide rod at a right angle to its longitudinal axis, onto which the reel is pluggable and preferably held with a securing member fastenable to the rotation axle. Advantageously, during the handling of the laying device, the reel is associated above the guide rod, so that the latter rests on the guide rod. In order to replaceably arrange the reel, a securing split pin or the like is preferably given as a securing member.

The heating cable pulled off from the reel is preferably fed through a feeding opening in the guide rod of the cable guide and guided out in the end region of the guide rod between the tabs. This arrangement has the advantage that a restricted guidance of the heating cable through the tabs is enabled at the end of the guide rod by means of the guidance in sections of the heating cable in the cable guide of the guide rod, so that the heating cable can be fed safely and in a manner oriented towards the guide of the roller. At the same time, tension can thereby be applied to the heating cable between the roller and the reel, so that stable conditions for safely unrolling the heating cable by the roller for fixing on the carrier plate are enabled.

The guide rod can preferably have an insertion aid at the grip-side end of the handle. This can be a curved trough-shaped surface that allows a large radius of curvature to be formed by the heating cable being unwound from a reel; for example, before the heating cable is fed to the cable feed on or in the guide rod. This facilitates the use and laying of the heating cable.

In the following, the invention and advantageous embodiments and further developments thereof are described and explained in more detail using the examples represented in the drawings. The features disclosed in the description and the drawings can be used individually per se or combined in any desired combination. In the drawings:

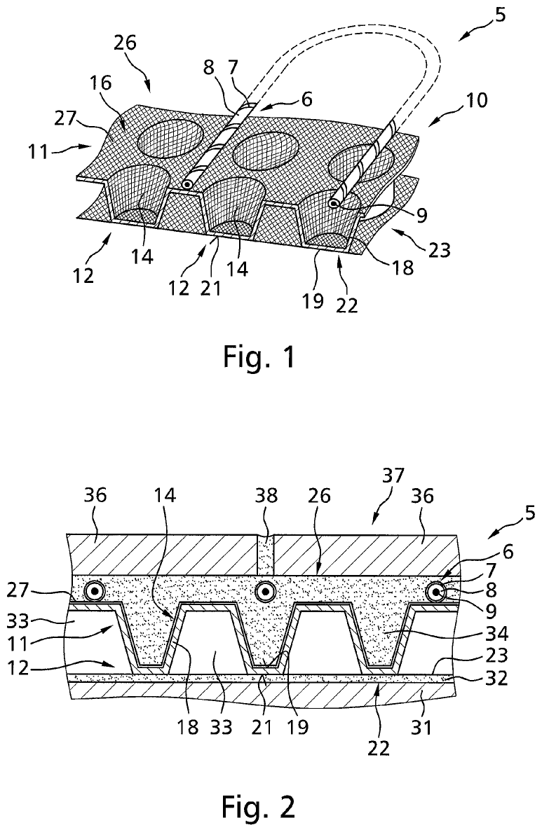

FIG. 1 shows a perspective representation of an electric surface temperature control system,

FIG. 2 shows a schematic sectional view of the electric surface temperature control system in an installation situation,

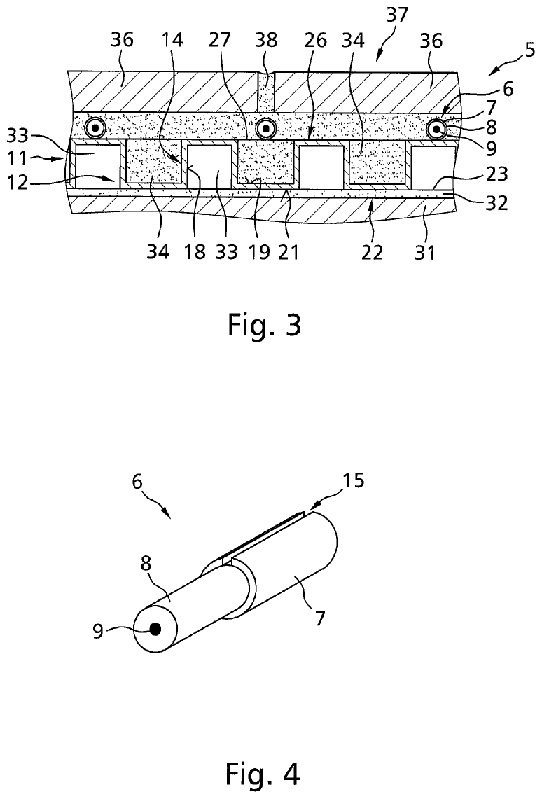

FIG. 3 shows a schematic sectional view of an alternative embodiment of the electric surface temperature control system in an installation situation,

FIG. 4 shows a perspective view of an alternative embodiment of a heating cable,

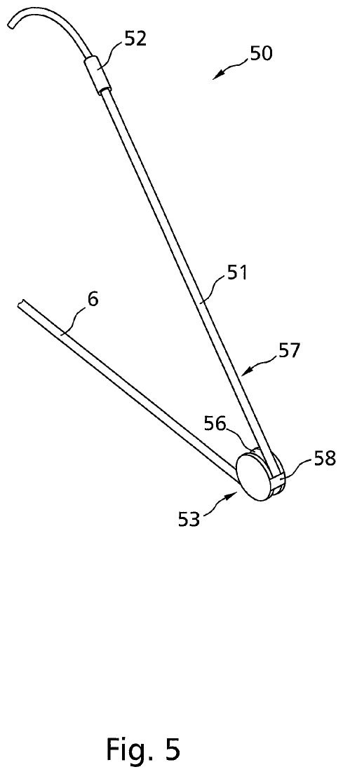

FIG. 5 shows a perspective view of a laying device,

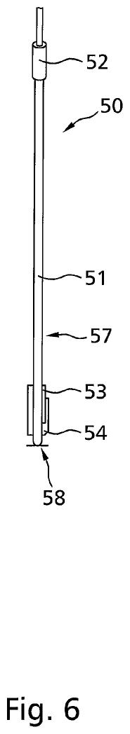

FIG. 6 shows a schematic view from the front onto the laying device according to FIG. 4,

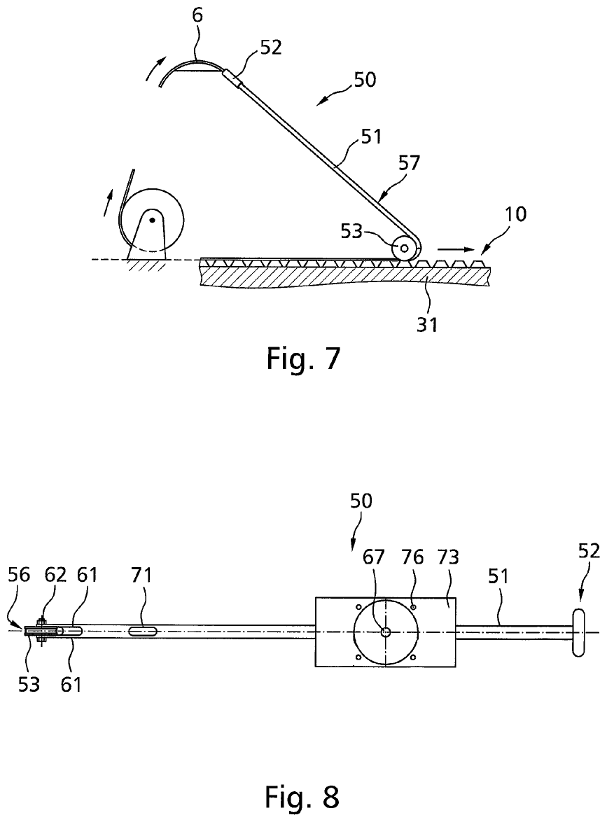

FIG. 7 shows a schematic side view of the laying device in use,

FIG. 8 shows a schematic view of an alternative embodiment of the laying device according to FIG. 5, and

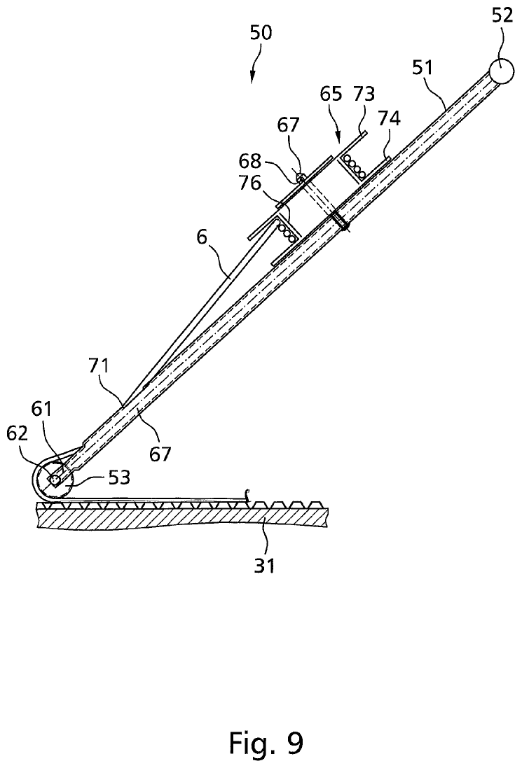

FIG. 9 shows a schematic side view of the laying device according to FIG. 8 in use.

FIG. 1 shows a perspective representation of an electric surface temperature control system 5. This electric surface temperature control system 5 comprises at least one carrier plate 10 and at least one heating cable 6. Furthermore, the electric surface temperature control system 5 comprises a control and/or a thermostat to control the heating cable. This is not shown in more detail.

This carrier plate 10 comprises a film-like plate 11 made of plastic, which has a plurality of chambers 12, which are formed by recesses 14 in the film-like plate 11. The preferably unidirectionally aligned recesses 14 of the chambers 12 have a preferably repetitive arrangement in rows and columns or fixed patterns otherwise relative to each other. Surface portions 16 are formed between the recesses 14, which surface portions connect the chambers 12 to one another. Starting from these surface portions 16, conically tapering wall portions 18 extend according to the first embodiment, which merge into a floor 19, which form a first plate side 22 with an outer end face 21. A fabric or non-woven 23 is laminated or welded onto the end faces 21 of the chambers 12, which clamps the carrier plate 10 in a contact layer applied to a ground, such as an adhesive or a mortar. The fabric or non-woven 23 is preferably in the form of a net-like fabric, in particular a fine-meshed mesh fabric or a perforated non-woven fabric. Such a fabric can be made of polypropylene, for example.

A second plate side 26 is provided opposite the first plate side 22, which is formed by the surface portions 16 connecting the chambers 12 and the recesses 14. A first functional layer 27 made of a sheet-like material is applied to this plate side 26, which lines at least one inner side of the recesses 14 and is connected to this inner side.

Preferably, this first functional layer 27 is also connected to the surface portions 16. Preferably, the second functional layer 27 is applied over the entire surface of the second plate side 26. Preferably, the first functional layer 27 is welded or laminated onto the film-like plate. In some cases, pressing or gluing on may also be provided. Thus, the first functional layer 27 comprises the same contour as the second plate side 26 of the carrier plate 10. According to a first preferred embodiment, the first functional layer 27 made of a sheet-like material is formed of a fibrous layer, a fine-meshed fabric, a scrim or a non-woven fabric, which may also be perforated. The first functional layer 27 is preferably a non-woven fabric made of polyethylene or polypropylene, for example. Likewise, the first functional layer 27 may have adhesion strengthening components. These can be formed, for example, in the form of glass fibres or granules that protrude at least partially from the surface of the first functional layer 27.

The heating cable 6 consists of a heating conductor 9, for example made of copper, and a sheathing 8, which forms an insulation. The sheathing 8 may consist of a polymer material. A second functional layer 7 is provided on the outer circumference of the heating cable 6. This second functional layer 7 can be a tape or strip-shaped material, which is formed as a hook tape on an outer side and comprises a contact surface for bonding to the sheathing 9 on an inner side. This second functional layer 7 may be held to the sheathing 9 by an adhesive bond. Preferably, at the functional layer 7, an adhesive layer or a double-sided adhesive tape is applied opposite to the hook tape. Alternatively, the sheathing 8 of the heating cable 6 may have a surface corresponding to a hook tape. Furthermore, instead of a helical or spiral wrap around the heating cable 6, the second functional layer 7, which is in the form of a band or strip, can alternatively be applied only longitudinally along the heating cable 6. Herein, the functional layer 7 may partially, for example by 60°, 90°, 180° or the like, or completely surround the sheathing 8. Also, two or more longitudinal strips, which are narrower than an outer diameter of the sheathing 8, may be provided in parallel to each other on the sheathing 8. These longitudinal strips may be provided in parallel to the longitudinal axis of the heating cable 6 or helically encircling on the heating cable 6.

The heating cable 6 can be laid both along the surface portions 16 and/or spanning the recesses 14 of the carrier plate 10. The formation of a hook-and-loop fastener on the surface portions 16 in front of and behind the recess 14 is sufficient to fix the heating cable 6 to the carrier plate 10.

FIG. 2 shows a schematic side view of the carrier plate 10 according to the invention in an installation situation. An adhesive or mortar 32 is applied to a ground 31, in particular screed. Subsequently, the film-like plate 11 with the fabric or non-woven 23 is laid on the ground 31. The mortar 32 clamps into the fabric or non-woven 23. The mesh size of the fabric or non-woven 23 or its perforation, if provided, is designed in such a way that, when the carrier plate 10 is laid, the mortar does not penetrate into regions 33, i.e. free spaces formed between the chambers 12, but it does clamp to the fabric or non-woven 23. This allows air to circulate in these open spaces.

An adhesive or mortar 34 is then applied to the second plate side 26. This mortar or adhesive 34 may also differ from the adhesive 32 applied to the ground 31. The mortar or adhesive 34 is thereby applied to the surface portions 16, the chambers 12 are filled, and the heating cable(s) 6 are surrounded by mortar or adhesive 34, so that preferably a flat and continuous bearing surface is formed by the mortar or adhesive 32 to receive and fix a surface covering 37 consisting of individual tiles or slabs 36. During the filling of the chambers 12 and the spreading of the mortar or adhesive 34 onto the surface portions 16, an interlocking of the adhesive or mortar 34 with this first functional layer 27 occurs due to the first functional layer 27. The laid position of the heating cable 6 on the carrier plate 10 is maintained by the hook-and-loop fastening formed between the first functional layer 27 on the carrier plate 10 and the second functional layer 7 on the heating cable. At the same time, so-called mortar bars can be formed in the recesses 14, via which a load transfer to the ground 31 takes place. After the plates 36 have been applied to form a surface covering 37 and the adhesive or mortar 34 has cured, joints 38 are introduced to complete the surface covering 37.

FIG. 3 shows an alternative embodiment of the carrier plate 10 according to the invention in an installation situation. The film-like plate 11 differs from the embodiment in FIG. 1 in that the chambers 12 have a perpendicular wall portion 18, thus forming cylindrical recesses 14. Otherwise, this embodiment corresponds to the embodiment according to FIGS. 1 and 2 and has the same advantages.

Alternatively to the design of the carrier plate 10 according to FIG. 1, the carrier plate 10 can be designed as a film-like plate made of plastic, which is flat. This alternative embodiment of the carrier plate is thus free of elevations and/or recesses 14. This carrier plate 10 may have the first functional layer 27 on the second plate side 26. Depending on the installation situation, the first plate side 27 may be provided with a third functional layer 23, in particular a mesh-like fabric, or may remain free of a third functional layer.

The carrier plate with the recesses 14 shown in FIGS. 1 to 3 also has the advantage of enabling uncoupling between the surface covering 37 and the ground 31 or the screed floor.

In FIG. 4, an alternative configuration of the heating cable 6 is shown in perspective. The structure of the heating cable 6 relative to the heating conductor 9 and the sheathing 8 corresponds to the above-described embodiment. In this embodiment, it is provided that the functional layer 7 is formed as a longitudinal strip, the width of which corresponds to an outer circumference of the sheathing 8. This second functional layer 7 completely surrounds the sheathing 8, so that a joint 15 running along the longitudinal axis of the heating cable 6 is formed by the two longitudinal sides of the second functional layer 7 formed as a longitudinal strip. This has the advantage that an improved adhesion is given opposite to the helical or spiral arrangement of the second functional layer 7 in applying to the carrier member 10 according to the embodiments in FIGS. 1 to 3. This complete sheathing 8 of the heating cable 6 by the second functional layer 7 does not adversely affect the laying direction or the type of laying of the heating cable 6, which preferably takes place in a meandering fashion.

FIG. 5 shows a perspective view of a laying device 50 for the heating cable 6 of the electric surface temperature control system 5. FIG. 6 shows a top view of the laying device 50 according to FIG. 5. The laying device 50 comprises a guide rod 51. A handle 52 is provided at one end of the guide rod 51. A roller 53 is arranged at the opposite end of the guide rod 51. This roller 53 can be rotatably received by a uniaxial holder 54, wherein the holder 54 is fastened to the guide rod 51. The roller 53 preferably has a guide 56. This guide 56 can be designed as a circumferential ridged groove. This guide 56 is preferably arc segment-shaped or semi-circular viewed in the cross-section. The size of the guide 56 is adapted to the outer diameter of the heating cable 6, so that during the unrolling of the heating cable 6 on the roller 53, a lateral hold of the heating cable 6 is provided by the roller 53.

A stand 58, for example in the form of a plate, may be provided in the guide rod 51 or the holder 54. This allows the laying device to assume an upright standing position when not in use.

The guide rod 51 is preferably designed as a tube. Thus, a cable feed 57 can be enabled within the guide rod 51. For example, the heating cable 6 is inserted into the guide rod 51 at the handle 52 and exits at the end of the guide rod 51 adjacent to the roller 53. Advantageously, an insertion aid for the heating cable 6 can also be provided on the handle 52 in the opposite direction to the guide rod 51.

At the front end of the guide rod 51, which is aligned with the roller 53, the guide rod 51 preferably has a curved area. The curvature is preferably adapted to the radius of the roller 53.

The laying device 50 makes it easy to lay the heating cable 6 on the carrier plate 10. This is shown in FIG. 7, for example. The heating cable 6 is preferably wound on a cable drum. This can make unrolling and laying easier. The cable drum can stand remotely on the floor or be carried by a worker; for example, in the form of a backpack. A first cable end is passed through the guide rod 51 and wrapped around the roller 53 and secured to the carrier plate 10. In this case, a hook-and-loop connection is created between the second functional layer 27 on the carrier plate 10 and the first functional layer 7 on the heating cable 6. Subsequently, the laying device 50 can be moved by means of the handle 52, wherein the roller 53 rolls on the carrier plate 10 and the heating cable 6 can be continuously fastened in position to the carrier plate 10, forming hook-and-loop fasteners. The course of the heating cable 6 on the carrier plate 10 within the room can be determined as desired or adapted to the cut and/or other circumstances. After laying the at least one heating cable 6 on the carrier plate(s) 10, the two ends of the respective heating cable 56 are attached to the control unit and connected to it; for example, for a function test. The surface covering 37, i.e. the application of the mortar 34 and the plates 36, can then be laid.

FIG. 8 shows a schematic view of an alternative embodiment of the laying device 50. FIG. 9 shows the laying device 50 according to FIG. 8 in a use position for laying the heating cable 6.

The laying device 50 comprises a guide rod 51, which is preferably tubular. At the upper end of the guide rod 51, the handle 52 is provided. Opposite thereto, at the other end of the guide rod 51, a roller 53 is received. In this embodiment, it is provided that the end of the guide rod 51 receiving the roller 53 is formed by two tabs 61 oriented in parallel to each other, which receive a rotation axle 62 for supporting the roller 53. On the guide rod 51, a reel 65 is preferably rotatably supported. This reel 65 is preferably supported replaceably to the guide rod 51, particularly by the through axle 67. This through axle 67 is fastened to the guide rod 51. Preferably, the through axle 67 is oriented at a right angle to the longitudinal axis of the guide rod 51. Onto this through axle 67, the reel 65 may be plugged in a replaceable manner. Preferably, a securing member 68 such as a securing split pin, for example, is provided to secure the reel 65 to the through axle 67. The reel 65 is preferably arranged in an upper half of the guide rod 51. Preferably, the reel 65 is arranged in a region within half a length of the guide rod 51 from the handle 52. In the exemplary embodiment, the reel 65 is supported resting on top of the guide rod 51. Alternatively, the reel 65 may also be supported hanging on the lower side on the guide rod 51.

The heating cable 6 to be laid is pulled off from the reel 65 and fed to a feeding opening 71 in the guide rod 51. This feeding opening 71 may be formed in the form of an elongated hole. Thereafter, the heating cable 6 in the cable feed 57 is guided to the tabs 61 in the guide rod 51. Subsequently, the heating cable 6 is guided through the tabs 61 and fed to the guide 56 on the roller 53. Preferably, the heating cable 6 is guided only in an end region in the cable feed 57 associated with the roller 53.

Alternatively, it may be provided that, instead of the above-described internal guide of the heating cable 6, holding tabs attached in the lower region of the guide rod 51 on the outer side of the guide rod 51 are provided. The holding tabs may be formed in an annular or U-shape in order to guide the heating cable 6 between the holding tab and the guide rod 51 or only in the holding tab.

The reel 65 may have an H-shaped cross-section, as shown in FIGS. 8 and 9. It comprises upper and lower cover plates 73, 74 as well as pins 56 arranged therebetween in order to receive the heating cable 6 in a circularly wound form. Alternatively, otherwise structured reels may also be provided.

1. An electric surface temperature control system for a floor, wall or ceiling construction,
with at least one heating cable,
with at least one carrier plate, which has a film-like plate made of plastic, which is flat or profiled, and comprises a first plate side, which is provided to rest on a ground and comprises a second plate side, which is opposite the first plate side and is provided for receiving a contact agent, such as mortar or adhesive, which is curable to form a contact layer with the surface covering to be applied, and with a first functional layer arranged on the second plate side,
wherein the first functional layer is formed from a fibrous layer, and
wherein a second functional layer is provided on the heating cable at least in sections, which second functional layer is formed from a hook tape and the heating cable is fastenable on the carrier plate by the first functional layer and second functional layer with the formation of a hook-and-loop fastener.

2. The surface temperature control system according to claim 1, wherein the at least one carrier plate, which comprises the film-like plate made of plastic is formed with a plurality of chambers formed by recesses and/or elevations from a plane of the film-like plate, the outer end faces of which form the first plate side and opposite the second plate side is formed by surface portions.

3. The surface temperature control system according to claim 2, wherein wall portions between the end faces forming the first plate side and the surface portions forming the second plate side extend perpendicularly or conically tapering from the surface portions to the end faces of the chamber.

4. The surface temperature control system according to claim 1, wherein the first functional layer consists of a sheet-like material and is at least partially or completely laminated, glued or welded onto the second plate side.

5. The surface temperature control system according to claim 4, wherein the first functional layer is fastened to the surface portions formed between the recesses and spans the recesses or lines the recesses of the chambers.

6. The surface temperature control system according to claim 1, wherein the first functional layer is formed from a felt, a non-woven, a fibrous fabric or a net-like fibrous fabric.

7. The surface temperature control system according to claim 1, wherein the second functional layer is designed in the form of a strip and surrounds the heating cable in the form of a spiral or helix or is formed as at least one longitudinal strip and fixed to the sheathing of the heating cable along the heating cable, wherein the at least one longitudinal strip at least partially encircles the sheathing of the heating cable or the one longitudinal strip completely surrounds the heating cable.

8. The surface temperature control system according to claim 1, wherein the second functional layer is integrated on the outer circumference of a sheathing of the heating cable.

9. The surface temperature control system according to claim 1, wherein the heating cable is fastenable to the surface portions adjacent to the recesses, resting on the surface portions and/or spanning the recesses, on the carrier plate with the formation of hook-and-loop fastening connections.

10. The surface temperature control system according to claim 1, wherein a third functional layer, in particular a fabric or a non-woven, is provided on the first plate side of the carrier plate.

11. The surface temperature control system according to claim 1, wherein the carrier plate with the first functional layer or the carrier plate with the first and third functional layers has a height of less than four millimetres.

12. A laying device for a heating cable of an electric surface temperature control system,
with a handle,
with a guide rod at one end of which the handle and, remote therefrom, a roller are provided on the guide rod,
with a cable feed, through which the heating cable provided with a second functional layer is feedable to the roller and is unrollable along a guide on the roller and fastenable on a carrier plate, which has a first functional layer of a fibrous layer on a second plate side.

13. The laying device according to claim 12, wherein the guide rod is tubular and the cable feed is provided at least partially or completely in the guide rod and/or in that the cable feed is formed by at least one guide tab formed or arranged on the guide rod.

14. The laying device according to claim 12, wherein the guide rod has a guide portion for the heating cable which is formed by two tabs formed at the end of the guide rod and rotatably receiving the roller, or which has a curved end portion at the end facing the roller, which curved end portion points towards the guide of the roller.

15. The device according to claim 12, wherein the roller has a radius, which is at least larger than the distance between two recesses in the carrier plate.

16. The laying device according to claim 12, wherein a reel for supplying the heating cable is rotatably and/or preferably replaceably provided on the guide rod.

17. The laying device according to claim 16, wherein a through axle is provided on the guide rod at a right angle to its longitudinal axis, onto which the reel is positionable and preferably held with a securing member.

18. The laying device according to claim 16, wherein the heating cable pulled off from the reel is feedable to the cable guide through a feeding opening in the guide rod and is feedable to the roller in a manner guided in the end region of the guide rod through the tabs.

19. The laying device according to claim 12, wherein an insertion aid for the heating cable into the cable feed is provided at one end of the guide rod on the handle side.
